(19) United States
(12) Patent Application Publication
(10) Pub. No.: US 2013/0114619 A1
(43) Pub. Date: May 9, 2013

(54) DEVICE AND METHOD FOR EGRESS PACKET FORWARDING USING MESH TAGGING

(71) Applicant: Shaun K Wakumoto, Roseville, CA (US)

(72) Inventor: Shaun K Wakumoto, Roseville, CA (US)

(21) Appl. No.: 13/809,724

(22) PCT Filed: Jul. 29, 2010
(86) PCT No.: PCT/US10/43656

§ 371 Date: Jan. 11, 2013

(51) Int. Cl. H04L 12/56

(52) U.S. Cl. CPC H04L 45/24
USPC 370/406

(57) ABSTRACT

A method for packet forwarding using a tag in a mesh network is described herein. A packet is received on a non-mesh port of a first mesh network device of the mesh network. One or more available paths between the first mesh network device and a second mesh network device are determined. A path of the one or more available paths is selected based on an egress forwarding rule associated with the path. A tag associated with the selected path is inserted into the packet. The packet is forwarded along the selected path.

### I. BACKGROUND

In conventional network computing environments, a number of devices are used in addition to interconnected computing systems to efficiently transfer data over the network. Routers and switches are in general network devices which segregate information flows over various segments of a computer network and forwards packets along a path towards a destination device.

In a typical Layer 2 environment, egress forwarding decisions are based on the destination Media Access Control (MAC) address of a packet. Standard port level restriction features allow restrictions on egress forwarding to be enforced. A packet received at one ingress port on a network device may be restricted from exiting from one or more egress ports on that same device. Port level restriction solutions are suitable when restricting egress forwarding decisions on a single network device. Such solutions are not well suited across multiple network devices since the destination network device does not have knowledge of the ingress port from which the packet entered the network.

Private virtual local area networks (VLANs) include ports that may be restricted across one or more devices, such that the ports communicate with an uplink and/or other ports within the same private VLAN group. However, private VLANs do not allow multiple VLANs to be established on a single port. As such, restrictions on egress forwarding decisions implemented using private VLANs are limited. Moreover, a VLAN group is assigned to packets according to the ingress port only.

### II. BRIEF DESCRIPTION OF THE DRAWINGS

The present disclosure may be better understood and its numerous features and advantages made apparent to those skilled in the art by referencing the accompanying drawings.

FIG. 1 is topological block diagram of a mesh network in accordance with an embodiment of the invention.

FIG. 2A is a process flow diagram for egress packet forwarding using mesh tagging at a source network device in accordance with an embodiment of the invention.

FIG. 2B is a process flow diagram for egress packet forwarding using mesh tagging in accordance with an embodiment of the invention.

FIG. 3 is a simplified high-level block diagram of a mesh network device including tables used for path selection and enforcement of an egress forwarding rule in accordance with an embodiment of the invention.

FIG. 4 is a topological block diagram of a mesh network in accordance with an embodiment of the invention.

FIG. 5 is another topological block diagram of a mesh network in accordance with an embodiment of the invention.

FIG. 6 is a block diagram of an exemplary switching or routing device in accordance with an embodiment of the invention.

### III. DETAILED DESCRIPTION OF THE INVENTION

Network devices and protocols associated therewith may be used to manage redundant paths between network devices. Where there is but a single path connecting two network devices, that single path, including all intermediate devices between the source and destination devices, represent a single point of failure in network communications between that source and destination device.

Redundant paths can be used to enhance reliability of the network. Multiple paths between two devices enhance reliability of network communication between the devices by allowing for a redundant (backup) network path to be used between two devices when a first path fails. A mesh is a network which provides use of the redundant paths even in the presence of path loops.

As used herein, a source network device is a network device, such as a switch or router, which is a point of entry of a packet into a particular mesh network. A destination network device is a network device within the mesh network which is an exit point of a packet out of a particular mesh network. As used herein, an intermediate network device is a network device within the mesh network and which is not a source network device or a destination network device.

Each network device in the mesh network has one or more available paths to each of the other mesh network devices. For example, a data packet may travel along any one of the available paths from a source network device to a destination network device.

In a mesh network, egress packet forwarding may be accomplished using mesh tagging. Typically for unicast traffic, tags are used to identify paths within the mesh from a source to a destination mesh network device. The tags may then be used as an index to determine the egress port of the destination network device, for example, using an egress forwarding table. As described herein, tags may be associated with egress forwarding rules. As such, restrictions may be placed on egress packet forwarding across multiple mesh network devices. Moreover, different egress restrictions may be enforced on multiple hosts of a single port.

A method for packet forwarding using a tag in a mesh network is described herein. A packet is received on a non-mesh port of a first mesh network device of the mesh network. One or more available paths between the first mesh network device and a second mesh network device are determined. A path of the one or more available paths is selected based on an egress forwarding rule associated with the path. A tag associated with the selected path is inserted into the packet. The packet is forwarded along the selected path.

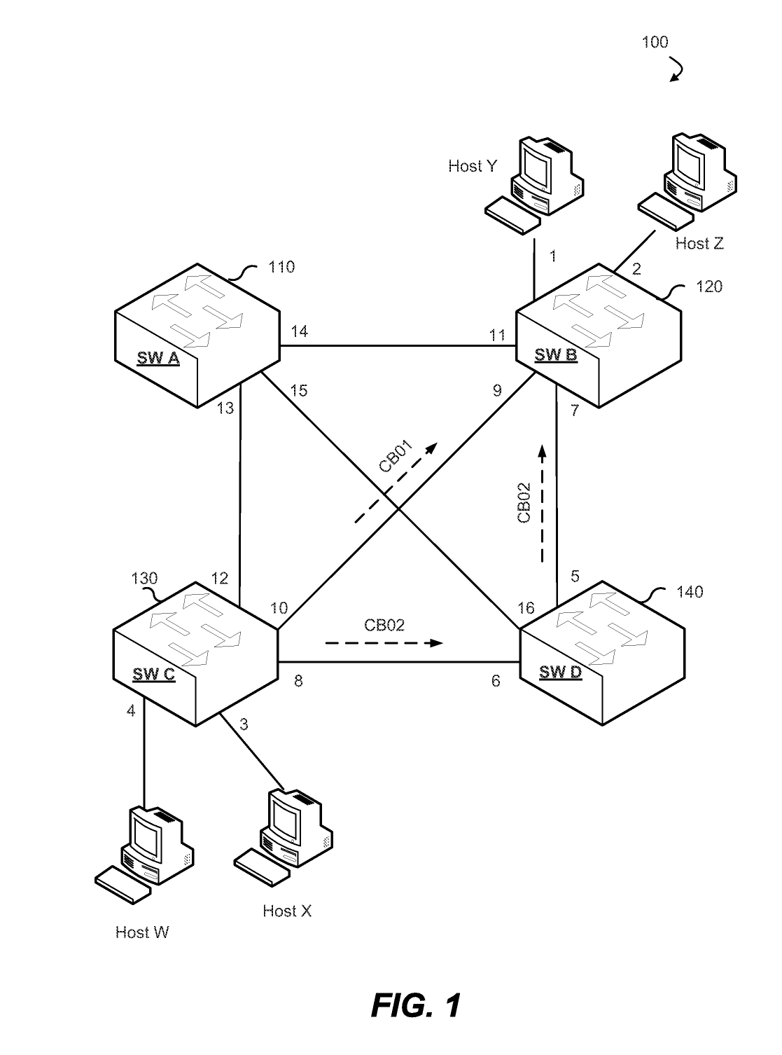

FIG. 1 is topological block diagram of a mesh network 100 in accordance with an embodiment of the invention. Mesh network 100 includes mesh switch A 110, mesh switch B 120, mesh switch C 130, and mesh switch D 140. As shown, mesh network 100 is employed as a full mesh topology where each of switches 110-140 is connected directly to each other. In another embodiment, mesh network 100 may be implemented in a partial mesh arrangement.

Host device Y is operatively coupled to switch B 120 via non-mesh port 1. Host device Z is operatively coupled to switch B 120 via non-mesh port 2. Host device W is operatively coupled to switch C 130 via non-mesh port 4. Host device X is operatively coupled to switch C 130 via non-mesh port 3. A host device is an originating source of the packet.

Switches 110-140 are configured to analyze and filter packets. Switches 110-140 are further configured to insert, remove, and analyze tags within the packets, select a path to a destination mesh switch, and assign a tag corresponding to the selected path. Furthermore, switches 110-140 are also configured to enforce one or more egress forwarding rules.

In one embodiment, each source/destination pair of mesh switches may be configured with multiple different paths. Each path may be associated with a unique path identifier.

In operation, when a packet is received by a non-mesh port of a switch in mesh network 100, the switch analyzes the received packet, selects a path to the destination mesh switch based on an egress forwarding rule associated with the path, and assigns a tag corresponding to the selected path to the packet. The switch then inserts the tag into the packet and forwards the packet along the selected path. As used herein, a non-mesh port is a port that does not connect to another mesh switch. For example, ports 1, 2, 3, and 4 are all non-mesh ports. It should be mentioned that packets that are forwarded out a mesh port go out with a path tag, whereas packets sent out a non-mesh port have this tag stripped.

In one embodiment, two hosts are operatively coupled to switch C 130, i.e., Host W and Host X. If Host W seeks to communicate with Host Z, the source mesh switch (i.e., switch C 130) has two available paths to the destination switch (i.e., switch B 120). A first path (CB01) may go directly from switch C 130 to switch B 120 by exiting port 10 of switch C 130 and entering port 9 of switch B 120. A second path (CB02) may travel from switch C 130 to switch B 120 via intermediate switch D 140 by exiting port 8 of switch C 130, entering port 6 of switch D 140, exiting port 5 of switch D 140, and entering port 7 of switch B 120.

Either path will allow packets from Host W to be transmitted to Host Z. Typical Layer 2 networking relies on the MAC address table on the destination switch to forward packets. In the case that the MAC address table of switch B 120 does not include Host Z and the traffic of Host W is a member of the same VLAN group as that of Host Y and Host Z, both Host Y and Host Z would receive the traffic of Host W. This may be viewed as a security issue, for example, if the data from Host W is sensitive. Moreover, if Host Y is a malicious user, the MAC address of Host Z may be spoofed by Host Y and as such, Host Y may receive the traffic destined for Host Z.

An egress forwarding rule may be configured, for example, by a network administrator, and associated with a tag for a particular path. The egress forwarding rule may seek to ensure that the traffic of Host W is delivered to the rightful destination host, i.e., Host Z, excluding others. For example, the egress forwarding rule may state that packets received on ingress at port 4 of switch C 130 are forwarded on egress through port 2 of switch B 120. This rule may be associated with a tag for path CB02. An egress forwarding table of switch B 120 may be configured to set port 2 as the egress port for packets that have a tag identifying path CB02.

When a packet is received by switch C 130, a path to switch B 120 may be selected based on the egress forwarding rule associated with the path. The forwarding rule associated with path CB02 applies to packets received on ingress at port 4 and destined to switch B 120. As such, switch C 103 determines whether the packet was received via port 4. If the packet was received at port 4, switch C 130 selects the path associated with the forwarding rule, i.e., path CB02. The tag corresponding to the selected path is inserted into the packet, which is then forwarded along in the mesh via the selected path.

The packet may be received by switch B 120. The tag in the packet is examined. An entry in the egress forwarding table of switch B 120 is found with the tag, and egress port 2 is identified as being associated with the tag. As such, the packet is forwarded to the rightful recipient, i.e., Host Z, via port 2. Since packets having a tag for path CB02 are permitted to exit port 2 and no other ports, in this example, Host Y does not receive Host Z's traffic unless Host Y is physically coupled to port 2.

The present invention can also be applied in other network topologies and environments. Mesh network 100 may include other types of networks familiar to those skilled in the art that can support data communications using any of a variety of commercially-available protocols, including without limitation TCP/IP, SNA, IPX, AppleTalk, and the like. Merely by way of example, network system 100 can be a local area network (LAN), such as an Ethernet network, a Token-Ring network and/or the like; a wide-area network; a logical network, including without limitation a logical private network (VPN); the Internet; an intranet; an extranet; a public switched telephone network (PSTN); an infra-red network; a wireless network (e.g.; a network operating under any of the IEEE 802.11 suite of protocols, the Bluetooth protocol known in the art, and/or any other wireless protocol); and/or any combination of these and/or other networks.

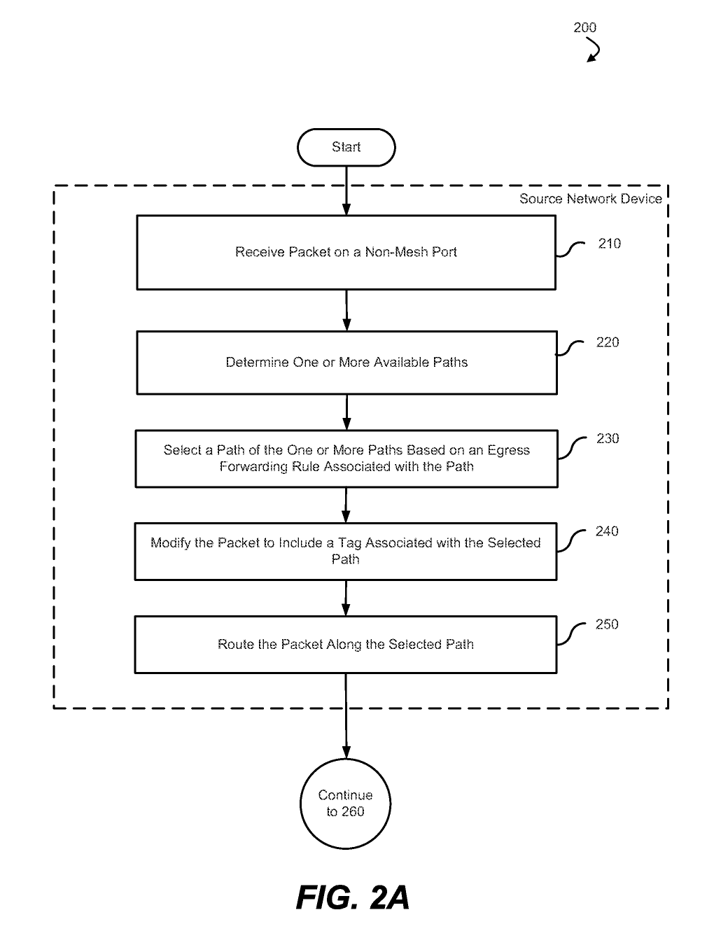

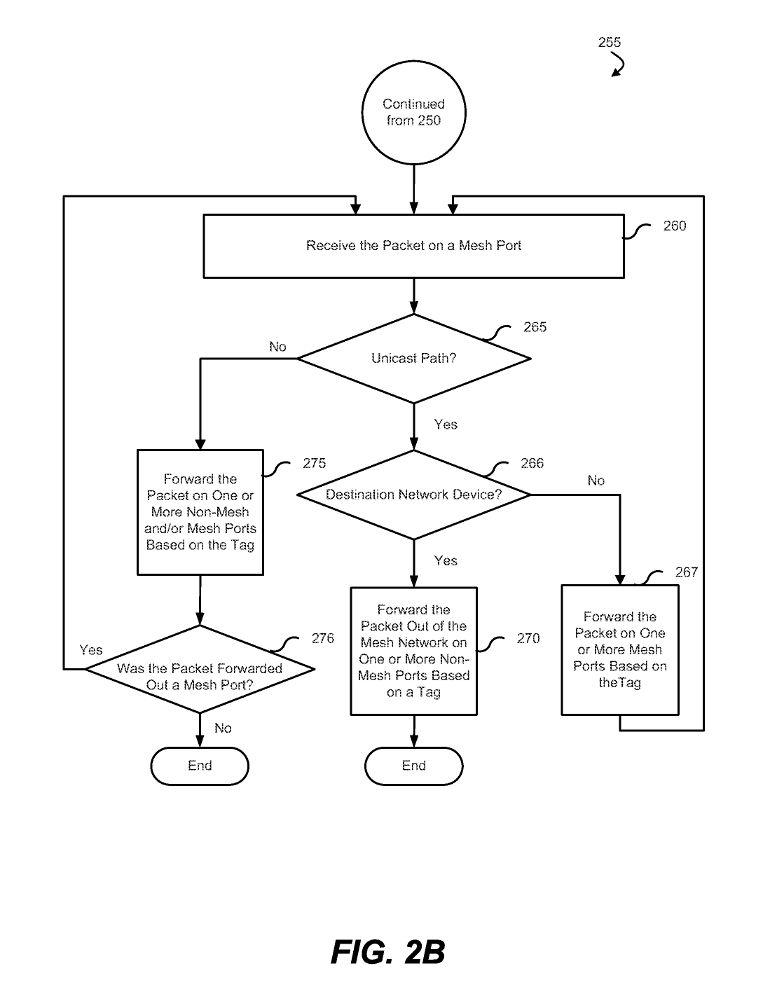

FIG. 2A is a process flow diagram for egress packet forwarding using mesh tagging at a source network device in accordance with an embodiment of the invention. The depicted process flow 200 may be carried out by execution of one or more sequences of executable instructions. In another embodiment, the process flow 200 is carried out by components of a networked device such as an egress forwarding module, an arrangement of hardware logic, e.g., an Application-Specific Integrated Circuit (ASIC), etc. For example, one or more steps of process flow 200 may be performed by a multiport controller ASIC of a source network device.

In one embodiment, a mesh network may include multiple mesh network devices, including a source network device, an intermediate network device, and a destination network device.

At step 210, a packet is received on a non-mesh port, for example at a source mesh switch. At step 220, one or more available paths to a destination mesh switch are determined.

At step 230, a path of the one or more paths may be selected based on an egress forwarding rule associated with the path. As used herein, an egress forwarding rule is a rule which imposes packet forwarding limitations on egress from a network device based on various ingress properties of the packet. The ingress properties may include ingress port, host, traffic type, location (source). VLAN, and/or timing information (e.g., time day, day of week, etc.). Each rule is comprised of an ingress component and an egress component (e.g., egress port(s)).

Each forwarding rule is associated with one or more path tags. The association between the egress forwarding rule to the tag may be configured by, for example, a network administrator, a default configuration, an automatic configuration tool, etc.

For example, an egress forwarding rule based on ingress port states that packets arriving into the mesh at port 1 of the source mesh switch can egress out of the mesh at ports 5, 6, and/or 7 of the destination mesh switch and no others.

An exemplary egress forwarding rule based on a host states that packets from source Host A can communicate with destination Host D and no others, where Host D is coupled to the destination network device at port 3 (i.e., egress port). The host information may be based on source MAC address, source IP address, or security associations as specified in the IEEE 802.1AE (MACsec) standard.

An exemplary egress forwarding rule based on traffic type states that ingress web traffic (i.e., traffic destined to web servers) is allowed to egress out of the uplink of the destination network device, which may be on port 19. The web server may be located on this port. Web traffic may be identified by examining a destination field of the packet on ingress and determining that the packet is destined to TCP port 80, 8080, and other known ports to which web servers typically adhere.

An exemplary egress forwarding rule based on location states that ingress packets from a source location such as a conference room is allowed to egress out of the uplink of the destination network device. The source location may be determined by examining the tag in the packet, which includes both the source mesh device and the destination mesh device.

An exemplary egress forwarding rule based on VLAN states that an ingress packet with a VLAN identifier of v100 is allowed to egress out of the uplink of the destination network device.

In one embodiment, one path may be selected over the other if a property of the packet received from a non-mesh port matches an egress forwarding rule associated with a path. In a more specific embodiment, a path may be selected if a property of the packet matches the ingress component of any forwarding rule. For example, if a forwarding rule associated with a path CB02 states that packets received on ingress at port 4 egress out of port 2, the ingress component of the rule is “ingress at port 4.” If the packet was received at port 4 (property of the packet), a match is determined and the path associated with the matching egress forwarding rule is selected.

The packet is modified to include a tag associated with the selected path, at step 240. In one embodiment, the tag is inserted into the packet. The packet is routed or otherwise forwarded along the selected path, at step 250. Processing may continue to step 260 of FIG. 23.

FIG. 2B is a process flow diagram for egress packet forwarding using mesh tagging at an intermediate network device in accordance with an embodiment of the invention. The depicted process flow 250 may be carried out by execution of one or more sequences of executable instructions. In another embodiment, the process flow 250 is carried out by components of a networked device such as an egress forwarding module, an arrangement of hardware logic, e.g., an Application-Specific Integrated Circuit (ASIC), etc. For example, one or more steps of process flow 250 may be performed by a multipart controller ASIC of an intermediate network device and/or destination network device.

In one embodiment, a mesh network may include multiple mesh network devices, including a source network device, an intermediate network device, and a destination network device. Processing may be continued from step 250 of FIG. 2A.

At step 260, the packet may be received on a mesh port, for example at a mesh network device. At this point, the path type (i.e., unicast, multicast, broadcast, etc.) is undetermined from the vantage point of the mesh network device. At step 265, it is determined whether the packet is a unicast packet. Where the packet is a unicast packet, processing continues to step 266. At this step, it is determined whether the network device that received the packet (at step 260) is a destination network device. The outcome of this decision block determines whether the receiving network device is an intermediate network device or a destination network device. Different forwarding mechanisms are employed for both. Various known methods of making this determination may be performed, such as using the information in the packet. For example, the path tag includes identifiers of both the source network device and the destination network device. As such, a receiving mesh device is able to determine if it is the destination network device by examining the tag, which is a part of the packet.

Where it is determined that the receiving network device is the destination network device for the packet, at step 270, the packet may be forwarded out of the mesh network on one or more non-mesh ports of the destination network device based on a tag. For example, the tag in the packet may be extracted and used to index an egress forwarding table in the destination network device. The egress forwarding table contains the correlation between tags and egress ports of the destination network device. The packet may be forwarded out of the egress port(s) corresponding to the tag.

It may be determined that the receiving network device is not the destination network device for the packet. As such, the receiving network device is an intermediate network device that is within the selected path of the packet. At step 267, the packet may be forwarded along the path on one or more mesh ports of the intermediate network device based on the tag. Unicast paths typically have a single mesh port that they can exit on an intermediate mesh switch. For example, the tag in the packet may be extracted and used to index an egress forwarding table in the intermediate network device. The packet may be forwarded out of the egress port corresponding to the tag. Processing continues to step 260.

At step 265, it may be determined that the path followed by the packet is not a unicast path. As such, the path type is multicast or broadcast. In either case, the packet is forwarded on one or more non-mesh and/or mesh ports of the receiving network device based on the tag. For example, the tag in the packet may be extracted and used to index an egress forwarding table in the receiving network device. The packet may be forwarded out of the egress port(s) corresponding to the tag. One or more of the egress port(s) may be mesh ports if there are other mesh ports to forward the packet on. In this sense, the receiving network device is an intermediate network device. One or more of the egress port(s) may be non mesh ports, for example where hosts are coupled to the non-mesh ports. In this sense, the receiving network device is a destination network device. In the context of multicasting or broadcasting, it is possible for the receiving network devices to be both intermediate and destination network devices. At step 276, it is determined whether the packet was forwarded out a mesh port at step 275. In that case, processing continues to step 260.

As such, the forwarding actions at steps 267, 270, and 275 effectively provide enforcement of the egress forwarding rule associated with the path, which was selected at step 230 of FIG. 2A. As such, egress forwarding limitations may be imposed across switches since the egress limitation is embodied by the tag and its associations.

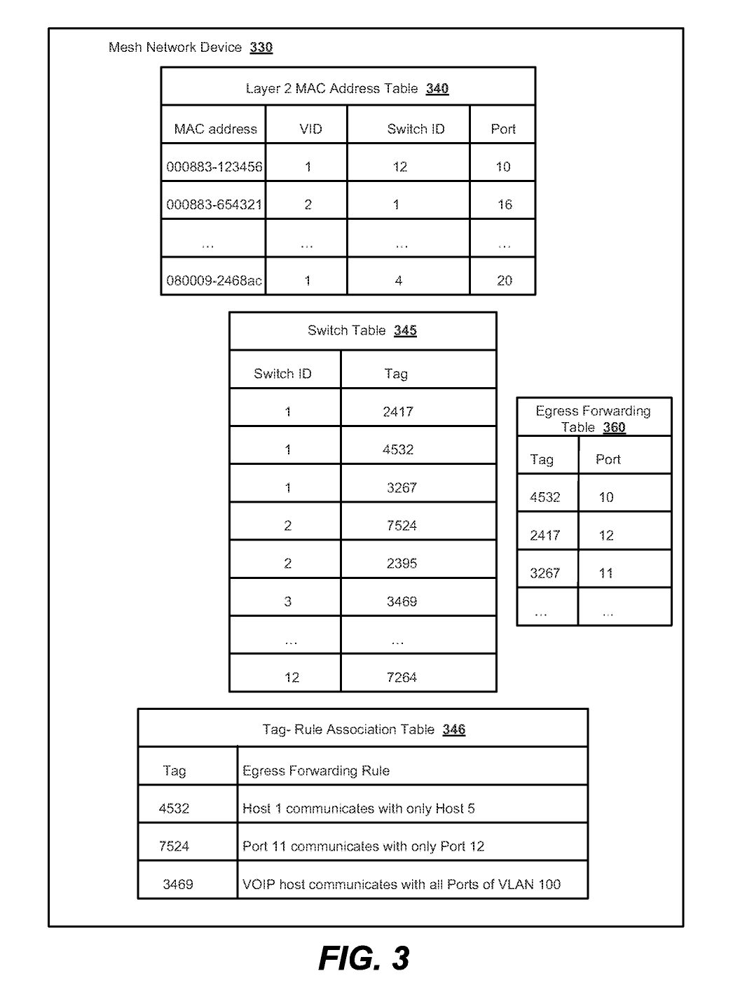

FIG. 3 is a simplified high-level block diagram of a mesh network device 330 including tables used for path selection and enforcement of an egress forwarding rule in accordance with an embodiment of the invention. Mesh network device 330 includes a Layer 2 MAC address table 340, a switch table 345, an egress forwarding table 360, and a tag-rule association table 346.

Layer 2 MAC address table 340 includes various fields such as a destination MAC address field, an associated VLAN identifier (VID) field, associated switch identifier (switch ID) field, and a port field. The switch identifier is associated with a MAC destination address. It is well understood that unicast, multicast, and broadcast packets are all associated with a destination MAC address field. In one embodiment, broadcast packets have a destination MAC address of FFFFFF-FFFFFF. Multicast packets have the lowest bit of the highest nibble set in the destination MAC address.

Switch table 345 includes various fields such as a switch ID field and a tag field. A tag identifies a particular path through a mesh network from a source network device to a destination network device. In one embodiment, the tag includes a source switch identifier, a destination switch identifier, and a path identifier. The path identifier is unique for each source/destination pair. Switch table 345 includes the correlation between intermediate or destination network devices and available path(s) for each network device. For example, the intermediate or destination network device having switch ID “1” has three different paths available for communication from source network device 330.

Egress forwarding table 360 contains the correlation between tags and ports. Egress forwarding table 360 includes a tag field and a port field. The port field specifies an egress port of mesh network device 330. The egress ports may be mesh or non-mesh ports. In one embodiment, egress forwarding table 360 includes another field that specifies whether a given tag represents a path that terminates at network device 330, thereby indicating that network device 330 is a destination switch. This field would indicate to the hardware that the tags should be removed or otherwise stripped from the packet before being sent out the non-mesh egress port In another embodiment, network device 330 may look at the switch identifier in the path tag itself to determine if it is the destination switch.

Tag-Rule association table 346 includes various fields such as a tag field and an egress forwarding rule field. The egress forwarding rule field includes egress forwarding rules, including an ingress component and/or an egress component (e.g., egress port). Tag-Rule association table 346 contains the correlation between tags and egress forwarding rules.

In operation, a packet may be received at a non-mesh port of mesh network device 330, which may be functioning as a source network device. A destination network device may be determined by gathering a MAC destination address from the packet. An entry in Layer 2 MAC address table 340 is located with the MAC destination address, and a VID and a switch identifier associated with the MAC destination address is obtained. One or more entries in switch table 345 are located using the switch identifier as an index. Using the tag field of the located entries in switch table 345, one or more tags of available paths are determined. Each tag is used to index Tag-Rule association table 346 and the corresponding egress forwarding rule is determined.

In one embodiment, for each of the one or more tags, it is determined whether the corresponding egress forwarding rule applies to the packet. More specifically, it is determined whether the corresponding egress forwarding rule is defined for an ingress property of the packet, such as ingress port, host, VLAN, traffic type, etc. Where the rule applies to the packet, the tag corresponding to the rule is selected and inserted into the packet. In one embodiment, multiple rules may be determined to apply to the packet. To lessen potential conflicts, each egress forwarding rule is associated with a priority level. The rule with the highest priority may be selected and the corresponding path tag is inserted into the packet. The inserted tag may reference an egress forwarding table of an intermediate and/or destination network device to forward the packet out the correct egress port.

In operation, a packet may be received at a mesh port of mesh network device 330, which may be functioning as an intermediate and/or destination network device. A tag is determined by examining the packet. The tag is used to index egress forwarding table 360 and correlating egress port(s) are determined. The packet may be forwarded out of the egress port(s).

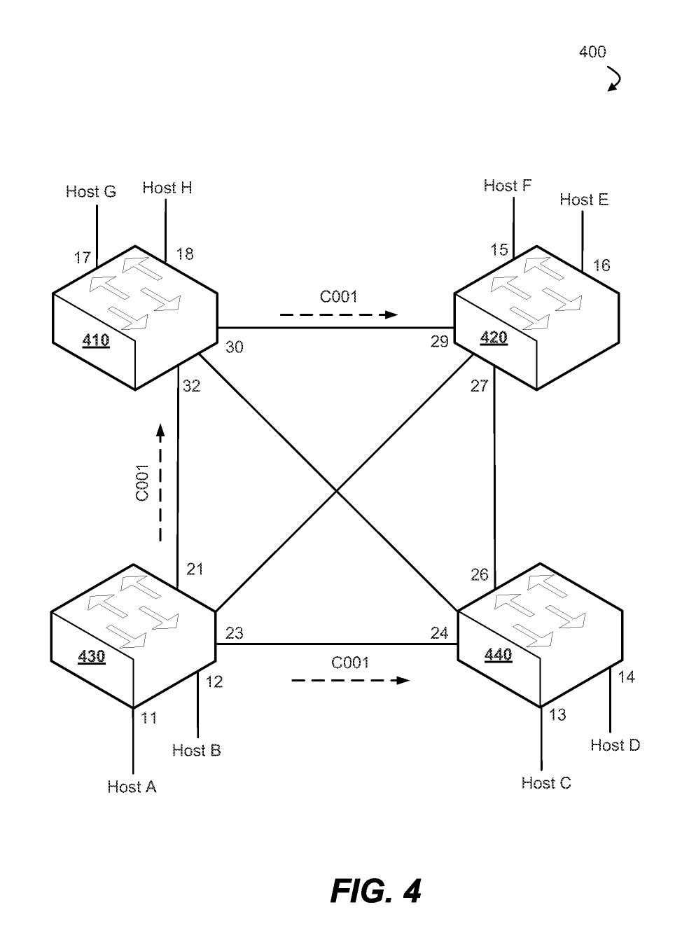

FIG. 4 is a topological block diagram of a mesh network in accordance with an embodiment of the invention. Egress forwarding rules may be used to restrict broadcast, multicast, and destination lookup failure (DLF) or unknown destination traffic. Mesh network 400 includes mesh switch 410, mesh switch 420, mesh switch 430, and mesh switch 440.

Host A is operatively coupled to mesh switch 430 at port 11, Host B is operatively coupled to mesh switch 430 at port 12. Host C is operatively coupled to mesh switch 440 at port 13. Host D is operatively coupled to mesh switch 440 at port 14. Host E is operatively coupled to mesh switch 420 at port 16. Host F is operatively coupled to mesh switch 420 at port 15. Host G is operatively coupled to mesh switch 410 at port 17. Host H is operatively coupled to mesh switch 410 at port 18.

As shown, path C001 is a mesh broadcast path. To place restrictions on broadcast traffic, for example, originating from Host A, an egress forwarding rule may recite that broadcast traffic from Host A is allowed to broadcast to Host C, Host F, and Host G. This rule may be associated with path tag C001. An egress forwarding table of mesh switch 440 may be configured for example by a network administrator to include one port, i.e., port 13 at which Host C is operatively coupled, as an egress port for path tag C001. Likewise, an egress forwarding table of mesh switch 420 may include one port, i.e., port 15 at which Host F is operatively coupled, as an egress port for path tag C001 and an egress forwarding table of mesh switch 410 may include one port, i.e., port 17 at which Host G is operatively coupled, as an egress port for path tag C001.

In operation, when a broadcast packet is received by source mesh switch 430, the available broadcast paths are determined. If the packet is from Host A, which may be determined by the ingress port, it is determined that the egress forwarding rule applies, and the path tag C001 is inserted into the packet before being routed through the mesh through ports 23 and 21.

Upon receipt of the packet by mesh switch 410, it is determined that the packet is a broadcast packet. The packet is forwarded on both egress mesh ports and egress non-mesh ports as dictated in the egress forwarding table of mesh switch 410. The packet is forwarded out non-mesh port 17 and mesh port 30. The packet is also received by mesh switch 440.

Upon receipt of the packet by mesh switch 420, it is determined that the packet is a broadcast packet. The packet is forwarded out of non-mesh port 15 and no others. The packet is not forwarded out mesh ports because there are no other mesh ports to forward the packet on.

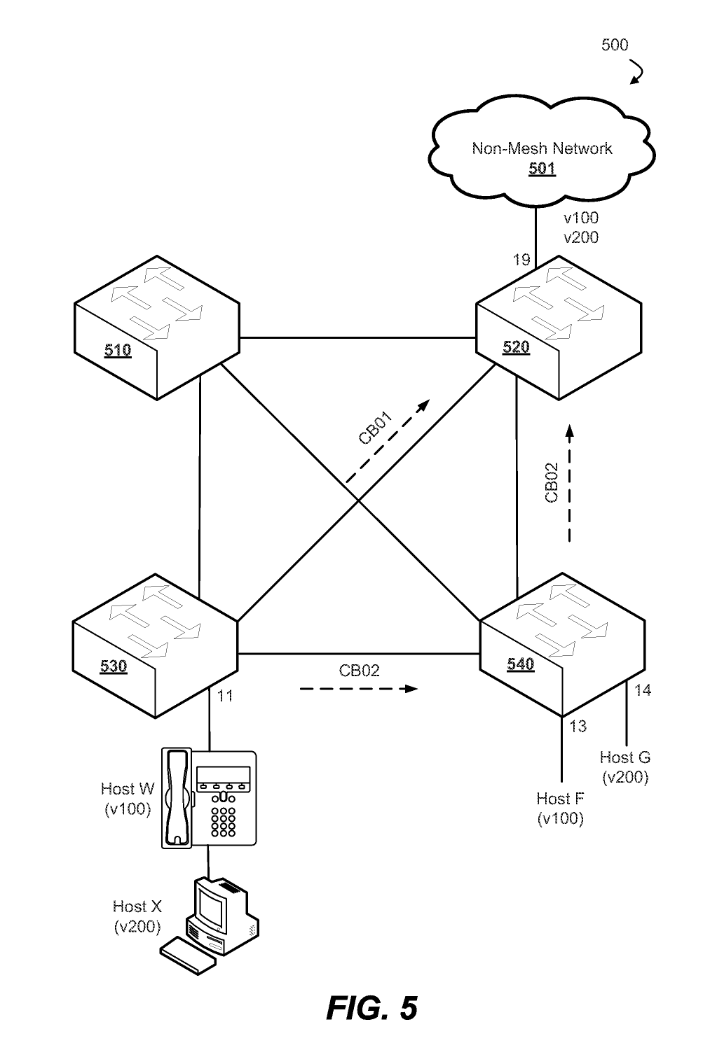

FIG. 5 is another topological block diagram of a mesh network in accordance with an embodiment of the invention. Mesh network 500 includes mesh switch 510, mesh switch 520, mesh switch 530, and mesh switch 540. Host W is operatively coupled to mesh switch 530 at port 11. In one embodiment, Host W is a Voice over Internet Protocol (VoIP) device, such as a VoIP phone. Host X is operatively coupled to mesh switch 530 at port 11 through Host W. In one embodiment, Host X is a personal computer (PC). In the context of VoIP solutions, it is common for a VoIP device to be connected to a port on one side and a PC on the other side, Non-Mesh Network 501 may be operatively coupled to mesh switch 520 through port 19. In one embodiment, port 19 is an uplink port. Host F is operatively coupled to mesh switch 540 at port 13. Host G is operatively coupled to mesh switch 540 at port 14.

The traffic of Host W and Host F are assigned to VLAN 100 (v100) and the traffic of Host X and Host G are assigned to VLAN 200 (v200). Typically, VLAN groups are associated with certain forwarding restrictions. In one embodiment, network administrators may want to be more restrictive, for example, such that a PC host is barred from communicating with all other hosts but allowed to communicate to an uplink, such as port 19 of mesh switch 520. It may be undesirable to limit voice traffic in this way, and as such network administrators may not want to limit the traffic from VoIP hosts.

This may be accomplished by creating an egress forwarding rule for each VLAN group, since Host W and Host X are members of different VLAN groups. For example, an egress forwarding rule may recite that traffic for v100 is unrestricted. Another egress forwarding rule may recite that traffic for v200 is restricted to egress port 19, which is the uplink port. Each rule may be associated with a unique tag, for example by the network administrator. The egress forwarding rule with respect to v200 may be associated with a tag for path CB02, whereas the egress forwarding rule with respect to v100 may be associated with a tag for path CB01.

In operation, when a packet arrives at port 11 on ingress, a VLAN identifier is assigned to the packet. The path corresponding to the egress forwarding rule for v100 traffic is selected for Host W's packets, i.e., path CB01. The path corresponding to the egress forwarding rule for v200 is selected for Host X's packets; i.e.; path CB02 which goes from mesh switch 530 to mesh switch 520, via mesh switch 540. Mesh switch 540 includes Host G. Even though Host X and Host G are on the same VLAN (i.e., v200), mesh switch 540 is aware of the policy that traffic from Host X is allowed to exit port 19 and no others. As such, the traffic of Host X is not permitted to egress any other ports.

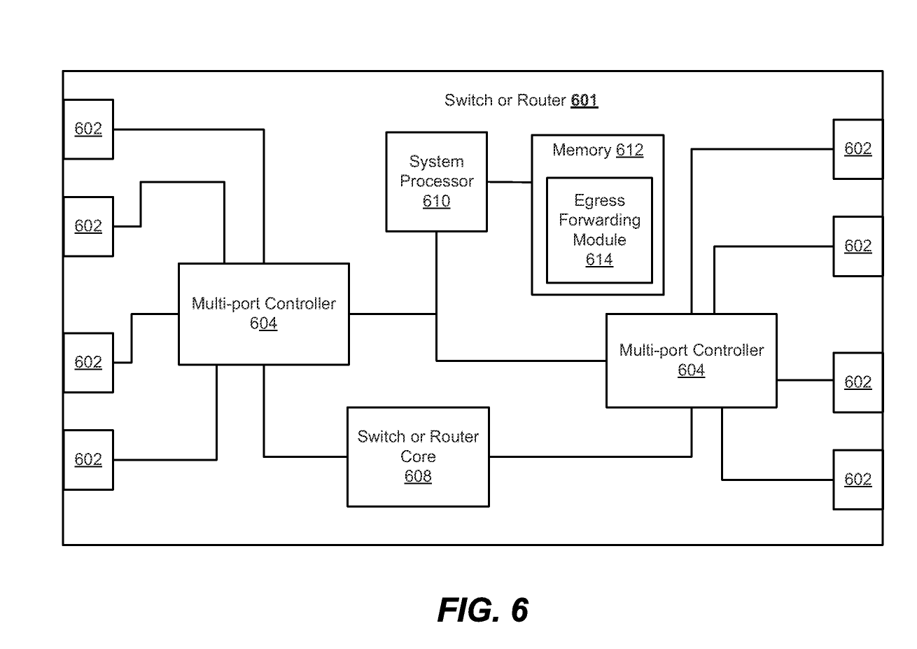

FIG. 6 is a block diagram of an exemplary switching or routing device in accordance with an embodiment of the invention. Switching or routing device 601 may be configured with multiple ports 602. One or more of multiple ports 602 is a non-mesh port configured to receive packets for subsequent forwarding through a mesh network and/or provide packets to a destination outside of the mesh network. The ports 602 may be controlled by one or more multi-port controller ASICs (application specific integrated circuits) 604, which are configured to determine one or more available paths, select a path of the one or more available paths, modify the packet to include a tag associated with the selected path, and route the packet along the selected path. Moreover, one or more multi-port controller ASICs 604 are further configured to forward packets on mesh and non-mesh ports based on a tag.

The device 601 may transfer (i.e. “switch” or “route”) packets between ports by way of a conventional switch or router core 608 which interconnects the ports. A system processor 610 and memory 612 may be used to control device 601. For example, an egress forwarding module 614 may be implemented as code in memory 612 which is being executed by the system processor 610 of a network device.

It will be appreciated that embodiments of the present invention can be realized in the form of hardware, software, firmware, or any combination thereof. Any such software may be stored in a computer system including a processor and a storage in the form of volatile or non-volatile storage, such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. The storage may be located outside of a node chip of a computer system such as a network device and may be operatively connected to a processor of the node chip. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are m ially exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The invention is not restricted to the details of any foregoing embodiments.

The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method for packet forwarding using a tag in a mesh network, the method comprising:
receiving a packet on a non-mesh port of a first mesh network device of the mesh network;
determining one or more available paths between the first mesh network device and a second mesh network device;
selecting a path of the one or more available paths based on an egress forwarding rule associated with the path;
inserting a tag associated with the selected path into the packet; and
forwarding the packet along the selected path.

2. The method of claim 1, wherein the egress forwarding rule specifies limitations on forwarding packets on egress through mesh network devices of the mesh network.

3. The method of claim 1, wherein selecting the path comprises comparing an ingress component of the egress forwarding rule to a property of the packet.

4. The method of claim 1, further comprising:
receiving the packet on a mesh port of a mesh network device of the mesh network; and
determining whether the packet is a unicast packet.

5. The method of claim 4, wherein the packet is a unicast packet, her comprising:
determining that the path of the packet within the mesh network terminates at the receiving mesh network device;
removing the tag from the packet; and
forwarding the packet out of one or more non-mesh ports corresponding to the tag.

6. The method of claim 4, wherein the packet is a unicast packet, further comprising:
determining that the path of the packet within the mesh network does not terminate at the receiving mesh network device; and
forwarding the packet out of a mesh port corresponding to the tag.

7. The method of claim 4, wherein the packet is not a unicast packet, further comprising forwarding the packet out of a port corresponding to the tag, wherein the port is at least one of a mesh port and a non-mesh port.

8. A network device for use in a mesh network for packet forwarding using a tag, the network device comprising;
a plurality of ports including a mesh port and a non-mesh port, wherein the non-mesh port is configured to receive a first packet;
a controller coupled to the plurality of ports, wherein the controller is configured to:
determine one or more available paths between the network device and a destination mesh network device;
select a path of the one or more available paths based on an egress forwarding rule associated with the path; and
insert a tag associated with the selected path into the first packet.

9. The network device of claim 8, wherein the egress forwarding rule specifies limitations on forwarding packets on egress through network devices of the mesh network.

10. The network device of claim 8, wherein the controller s configured to select the path by comparing an ingress component of the egress forwarding rule to a property of the packet.

11. The network device of claim 8, wherein the mesh port is configured to receive a second packet, and wherein the controller is configured to determine whether the second packet is a unicast packet.

12. The network device of claim 11, wherein the second packet is a unicast packet, and wherein the controller is configured to:
determine that the path of the second packet within the mesh network terminates at the network device;
remove the tag from the second packet; and
forward the second packet out of one or more non-mesh ports of the plurality of ports corresponding to the tag.

13. A method for packet forwarding using a tag in a mesh network, the method comprising:
receiving a packet on a mesh port of a network device of the mesh network, the packet including a tag associated with a path within the mesh network, wherein the path is selected based on an egress forwarding rule associated with the path;
determining a path identifier from the tag;
finding an entry in an egress forwarding table using the path identifier;
obtaining one or more egress ports associated with the path identifier in the entry of the egress forwarding table; and
forwarding the packet through the one or more egress ports of the network device.

14. The method of claim 13, wherein the one or more egress ports is a mesh port of the network device where the packet is a unicast packet and the path does not terminate at the network device.

15. The method of claim 3, wherein the one or more egress ports are non-mesh ports of the network device where the packet is a unicast packet and the path terminates at the network device.
